(19) United States
(12) Patent Application Publication
(10) Pub. No.: US 2024/0269649 A1
(43) Pub. Date: Aug. 15, 2024

(54) Porous Polymer Product For Removing Contaminants From A Fluid Stream

(71) Applicant: Celanese International Corporation, Irving, TX (US)

(72) Inventor: Hendrich Chiong, Cincinnati, OH (US)

(21) Appl. No.: 18/431,505

(22) Filed: Feb. 2, 2024

Related U.S. Application Data
(60) Provisional application No. 63/443,239, filed on Feb. 3, 2023.

(51) Int. Cl. B01J 20/26; B01J 20/28; B01J 20/30; C02F 1/00; C02F 1/28; C02F 101/20

(52) U.S. Cl. CPC B01J 20/262; B01J 20/2805; B01J 20/28083; B01J 20/3078; C02F 1/001; C02F 1/285; C02F 2101/203; C02F 2201/006

(57) ABSTRACT

A porous polymer product is disclosed that is particularly well suited to filtering fluid streams for removing contaminants. The contaminant, for instance, can be a metal contained in the fluid stream in trace amounts, such as rhodium. The porous polymer product can be made from one or more polybenzimidazole polymers. In one aspect, the one or more polybenzimidazole polymers can be sintered together into a shape suitable for a particular application.

### RELATED APPLICATIONS

The present application is based upon and claims priority to U.S. Provisional Application Ser. No. 63/443,239, having a filing date of Feb. 3, 2023, which is incorporated herein by reference.

### BACKGROUND

In many industrial and commercial processes, small amounts of contaminants or impurities can be present and/or accumulate in various fluid streams. Depending upon the process, removal of these contaminants may be desirable in order to increase the purity of the product being produced. In many instances, the contaminants may also represent valuable resources, such as precious metals. In these instances, value can be lost if the contaminants are not removed, reclaimed, and reused.

The need to remove contaminants from liquid streams can occur in various types of different industries and processes. For instance, heavy metals and precious metals are typically present in many water treatment streams. Other industries where contaminant removal is needed is the food and beverage industry, the pharmaceutical field, the oil and gas industry, the pulp and paper industry, and all different types of chemical manufacturing processes. For instance, any process that employs a catalyst typically produces small amounts of impurities generated by the catalyst materials and supports.

In the past, many chemical scavengers, such as metal scavengers, were employed in the form of relatively small particles. In some applications, the small particles were added to a cartridge in order to form a fixed bed for filtering fluids therethrough. Although the scavengers can be very effective at removing contaminants, the manner in which they are employed has created various drawbacks and problems. The fixed bed cartridges, for instance, can create relatively large pressure drops requiring significant amounts of energy in order to filter the liquids. The small particle sizes are also difficult to handle and process. Further, many of the cartridges have flow limitations that are not capable of accommodating the flow rates found in many industrial processes.

In addition to scavengers in the form of small particles, others have proposed capturing the scavengers in shaped articles. For instance, U.S. Pat. No. 9,215,891, which is incorporated herein by reference, describes forming porous polymer materials containing a polyvinyl polypyrrolidone in the shape of a frit, a sheet, a tube, a disk, or a roll. These shaped articles, in the form of rigid unitary bodies, however, are not amenable to all different types of processes and may lack sufficient surface area for some processes.

In view of the above, a need currently exists for a versatile porous polymer product containing a chemical scavenger that can be formed into all different sizes and shapes. A need also exists for a porous polymer product that has improved porosity characteristics and/or improved scavenger availability for facilitating removal of chemical species from liquid streams.

### SUMMARY

In general, the present disclosure is directed to a porous polymer material containing a chemical scavenger. The porous polymer material can be comprised of a sintered chemical scavenger. In one aspect, the chemical scavenger can be polybenzimidazole.

The porous polymer material of the present disclosure can offer various advantages and benefits. For instance, the process of producing the porous polymer material is versatile and can be used to produce any suitable shape. Further, the chemical scavenger is exposed within the porous network in a manner that fluids contacting the porous structure come into contact with the chemical scavenger for removing contaminants from the fluid.

In one embodiment, for instance, the present disclosure is directed to a porous filter element comprising a porous substrate. The porous substrate can include a porous structure formed from a chemical scavenger. The chemical scavenger, for instance, can be polybenzimidazole. In one aspect, the porous filter element or porous structure can be formed by sintering polybenzimidazole into any suitable shape. For instance, the porous filter element can have a solid spherical or solid cylindrical shape. In one aspect, the porous filter element can have a three-dimensional, non-planar shape and can have a greatest dimension of at least 0.5 mm. Thus, not only is the porous filter element well suited to filtering fluids, but is also easy to handle and insert into industrial processes.

In accordance with the present disclosure, the porous substrate can have a porosity of greater than about 10%, such as greater than about 20%, such as greater than about 30%, such as greater than about 40%, such as greater than about 50%, such as greater than about 60% and less than about 85%. The porous substrate can also display an average pore size of greater than about 4 nm, such as greater than about 4.2 nm, such as greater than about 4.4 nm, such as greater than about 4.6 nm, such as greater than about 4.8 nm, such as greater than about nm, such as greater than about 5.2 nm, such as greater than about 5.4 nm, such as greater than about 5.6 nm, and less than about 30 nm, such as less than about nm, such as less than about 15 nm, such as less than about 10 nm, such as less than about 8 nm.

The porous filter elements can also display a BET surface area of greater than about 0.03 m²/g, such as greater than about 0.05 m²/g, such as greater than about 0.07 m²/g, such as greater than about 0.09 m²/g, such as greater than about 0.11 m²/g, such as greater than about 0.13 m²/g, such as greater than about 0.15 m²/g, such as greater than about 0.17 m²/g, such as greater than about 0.19 m²/g, such as greater than about 0.21 m²/g, such as greater than about 0.23 m²/g, such as greater than about 0.25 m²/g, such as greater than about 0.27 m²/g, such as greater than about 0.29 m²/g, such as greater than about 0.31 m²/g, such as greater than about 0.33 m²/g, such as greater than about 0.35 m²/g, such as greater than about 0.37 m²/g, and less than about 0.7 m²/g.

In another aspect, the present disclosure is also directed to a process for removing contaminants from a fluid stream. The process includes contacting a fluid stream containing at least one contaminant with a porous filter element. The porous filter element comprises a porous structure formed from polybenzimidazole. For example, the porous structure can be formed by sintering polybenzimidazole into any suitable shape. The porous filter element can be net shaped molded or can be molded into a shape and then ground to a particular particle size. During the process, the contaminant contained in the fluid stream can comprise an ion that binds to the chemical scavenger contained in the porous structure of the porous filter element. The contaminant, for instance, can comprise a metal, such as rhodium, palladium, platinum, iron, copper, mercury, or mixtures thereof.

The porous filter element can comprise polybenzimidazole in an amount greater than about 60% by weight, such as in an amount greater than about 70% by weight, such as in an amount greater than about 80% by weight, such as in an amount greater than about 90% by weight. In one embodiment, the porous filter element is made essentially or entirely from polybenzimidazole and may contain no binders. In one aspect, the porous filter elements can be contained in a cartridge that is contacted with the fluid stream. For instance, a plurality of the porous filter elements can form a fixed bed in the cartridge through which the fluid stream is filtered. The process can further include the step of removing and recovering the contaminant from the chemical scavenger.

The process of the present disclosure can be used in all different types of processes. For instance, the fluid stream can be part of a pulp and paper process, part of a water treatment process, part of a beverage purification process, part of an oil and gas process, part of a catalyst recovery process, part of a pharmaceutical process, or part of a chemical purification process.

The present disclosure is also directed to a device for filtering fluids. The device can comprise a cartridge including a fluid inlet and a fluid outlet. The cartridge can define an interior enclosure. A bed of unfastened porous filter elements can be loaded into the interior enclosure of the cartridge. The unfastened porous filter elements can have a greatest dimension of at least about 0.5 mm. Each porous filter element can comprise a porous structure. Each porous filter element can be formed from a chemical scavenger comprising polybenzimidazole. The chemical scavenger is configured to be exposed to fluids flowing through the cartridge.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a plan view of one exemplary embodiment of a porous polymer product made in accordance with the present disclosure;

FIG. 2 is a plan view of another embodiment of a porous polymer product made in accordance with the present disclosure;

FIG. 3 is a diagram of one embodiment of a carbonylation process in accordance with the present disclosure; and

FIG. 4 is a diagrammatic view of another embodiment of a carbonylation process in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a porous polymer product containing at least one chemical scavenger. The chemical scavenger, for instance, can be a polybenzimidazole polymer. In one aspect, polybenzimidazole polymer particles can be sintered together in order to form the porous polymer product that is well suited to removing contaminants from fluid streams, such as liquid streams. The porous polymer product, for instance, can have a porosity and other properties that makes the product well suited for use as a porous filter element that is configured to be contacted with fluid streams.

The polybenzimidazole polymer particles can be sintered into any suitable shape. In this manner, the shape of the porous polymer product can be selected such that the product is not only well suited to filtering fluids but also is easy to handle and can contact fluid streams without creating excessive pressure drops.

The porous polymer products of the present disclosure offer numerous advantages and benefits. For instance, the porous polymer products of the present disclosure offer versatility. The ability to form the chemical scavenger into a porous structure, for instance, eliminates process drawbacks and limitations experienced when handling small particle sizes. The porous polymer products of the present disclosure thus simplify large scale utilization of chemical scavengers, particularly polybenzimidazole. Encasing the chemical scavenger into the porous polymer structure also reduces dust generation and dramatically facilitates handling of the chemical scavenger. Thus, the porous polymer products are not only more efficient to use but promote worker safety. In addition, the porous polymer structures of the present disclosure also eliminate the need for “polishing” of fine particles of scavengers.

During sintering, the polybenzimidazole particles are compacted and formed into a solid mass without melting the polymer using heat and/or pressure. Sintering polybenzimidazole particles in accordance with the present disclosure produces porous structures having fluid capillaries that allow fluids to contact the chemical scavenger when placed in a fluid.

Polybenzimidazole can be an effective chemical scavenger for various chemical species. For instance, polybenzimidazole can efficiently bind to polyphenols, enzymes, proteins, and the like. The above chemical species, for instance, are desirably removed from various beverages including beer. In other applications, the polybenzimidazole can be used to remove metal ions from solutions in all different types of applications. Metal ions that can be removed include lithium, sodium, potassium, rubidium and cesium; alkaline earth metals such as beryllium, magnesium, calcium, strontium and barium; transition metals such as zinc, molybdenum, cadmium, scandium, titanium, vanadium, chromium, manganese, iron, cobalt, nickel, copper, yttrium, zirconium, niobium, technetium, ruthenium, rhodium, palladium, silver, hafnium, tantalum, tungsten, rhenium, osmium, iridium, platinum and gold; lanthanoids such as lanthanum, cerium, praseodymium, neodymium, promethium, samarium, europium, gadolinium, terbium, dysprosium, holmium, erbium, thulium, ytterbium and lutetium; actinides such as thorium, uranium, neptunium and plutonium; and p-block metals such as aluminium, gallium, indium, tin, thallium, lead and bismuth. Polybenzimidazole, for instance, is particularly effective at removing rhodium from various industrial processes, especially processes that use catalysts containing rhodium.

Polybenzimidazole polymer resins that may be used to produce porous polymer products in accordance with the present disclosure can, in one embodiment, have the following formula:

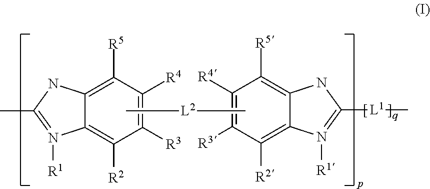

wherein R¹ to R₅ and R^{1′} to R^{5′} are substituents selected independently;
L¹ is a divalent bonding group;
L² is a divalent bonding group that connects either one of R¹ to R⁵ to either one of R^{1′} to R^{5′}; and
P and q are numbers indicating the degree of polymerization.

In the above formula, it is preferable that R¹ to R⁵ and R^{1′} to R^{5′} be independently hydrogen, an alkyl group having 1 to 10 carbon atoms, an aryl group having 6 to 12 carbon atoms, a halogen, hydroxyl group, or an alkoxyl group having 1 to 10 carbon atoms, and that L¹ and L² be independently single bond, or a divalent bonding group consisting of chalcogen or an aromatic, aliphatic, alicyclic or heterocyclic compound.

In the case where L¹ or L² is a bonding group comprising an aliphatic compound, the bonding group can be an alkylene having 1 to 8 carbon atoms, such as an alkylene having 4 to 8 carbon atoms. When L¹ or L² is a bonding group comprising an aromatic compound, the bonding group can be phenylene or naphthylene. When L¹ or L² is a bonding group comprising a heterocyclic compound, the bonding group can be pyridinylene, pyrazinylene, furanylene, quinolinylene, thiophenylene, pyranylene, indenylene or furylenylene. In the case where L¹ or L² is a bonding group comprising chalcogen, the bonding group can be —O—, —S— or —SO₂—.

Specific examples of polybenzimidazoles represented by the above formula include the following polymers and copolymers:
poly-2,2′-(m-phenylene)-5,5′-dibenzimidazole,
poly-2,2′-(diphenylene-2″,2″′)-5,5′-dibenzimidazole,
poly-2,2′-(diphenylene-4″,4″′)-5,5′-dibenzimidazole,
poly-2,2′-(1″ 1″,3″-trimethylindanylene)-3″,5″-p-phenylene-5,5′-dibenzimidazole,
2,2′-(m-phenylene)-5,5′-dibenzimidazole/2,2′-(1″,1″,3″-trimethylindanylene)-5″,3″-(p-phenylene)-5,5′-dibenzimidazole copolymer,
2,2′-(m-phenylene)-5,5′-dibenzimidazole/2,2′-diphenylene-2″,2″′-5,5′-dibenzimidazole copolymer,
poly-2,2′-(furylene-2″ 5″)-5,5′-dibenzimidazole,
poly-2,2′-(naphthalene-1″,6″)-5,5′-dibenzimidazole,
poly-2,2′-(naphthalene-2″,6″)-5,5′-dibenzimidazole,
poly-2,2′-amylene-5,5′-dibenzimidazole,
poly-2,2′-octamethylene-5,5′-dibenzimidazole,
poly-2,2′-(m-phenylene)-diimidazobenzene,
poly-2,2′-cyclohexenyl-5,5′-dibenzimidazole,
poly-2,2′-(m-phenylene)-5,5′-di(benzimidazole)ether,
poly-2,2′-(m-phenylene)-5,5′-di(benzimidazole)-sulfide,
poly-2,2′-(m-phenylene)-5,5′-di(benzimidazole)-sulfone,
poly-2,2′-(m-phenylene)-5,5′-di(benzimidazole)-methane,
poly-2,2′-(m-phenylene)-5,5′-di(benzimidazole)-propane-2,2, and
poly-ethylene-1,2,2,2″-(m-phenylene)-5,5″-di(benzimidazole)ethylene-1,2, provided that the double bond of the ethylene group remains as it is even in the final polymer.

In one aspect, the polybenzimidazole resin is poly-2,2′-(m-phenylene)-5,5′-dibenzimidazole.

The polybenzimidazole can have an intrinsic viscosity (IV) at 25° C. of 0.4 dl/g or more and a particle diameter, as determined by a laser-scattering particle size distribution meter manufactured by Horiba, Ltd., Japan, of 500 μm or less, such as 150 μm or less, and about 20 μm or greater, such as about 50 μm or greater.

In addition to the above, the water content of the polybenzimidazole polymer can also be controlled prior to sintering. The presence of water vapor, for instance, can influence porosity and pore size. Thus, the polybenzimidazole particles can be dried to have a particular amount of moisture content when sintered. In one aspect, the content of water in the polybenzimidazole particles is less than about 0.3% by weight, such as less than about 0.2% by weight, such as less than about 0.1% by weight. The amount of water can generally be greater than about 0.01% by weight, such as in an amount greater than about 0.05% by weight, such as in an amount greater than about 0.08% by weight, such as in an amount greater than about 0.11% by weight.

In addition to moisture content, various other additives can be incorporated or controlled in order to change one or more properties of the porous polymer product.

In one embodiment, a leaching agent can be combined with the polybenzimidazole during formation of the porous structure (e.g. prior to sintering). The leaching agent can be added during production of the porous substrate and then later removed for increasing the porosity and/or otherwise altering or changing the pore size for optimum results. The leaching agent, for instance, can be solvent soluble. In this manner, the porous structure of the porous polymer product can be formed and then contacted with a solvent for removing the leaching agent. In this manner, the porosity of the resulting porous polymer product can be increased.

In general, any suitable leaching agent that does not adversely interfere with the one or more chemical scavengers can be incorporated into the product. In one aspect, the leaching agent can be a water soluble salt. The water soluble salt can be, for instance, an alkali or alkaline earth metal salt that can, for instance, be combined with a halide, such as chloride. One example of a water soluble leaching agent is sodium chloride.

In addition to water soluble leaching agents, it should be understood that various other solvent soluble compounds or polymers can be used. For instance, the leaching agent can be soluble in an organic liquid, such as an alcohol, acetone, or other solvent.

One or more leaching agents can be initially combined with the components used to produce the porous structure in various amounts depending upon the application. For instance, one or more leaching agents can be incorporated into the component mixture used to form the porous polymer product in an amount generally greater than about 1% by weight, such as in an amount greater than about 3% by weight, such as in an amount greater than about 5% by weight, such as in an amount greater than about 8% by weight, such as in an amount greater than about 10% by weight, such as in an amount greater than about 12% by weight. One or more leaching agents can be present in the components generally in an amount less than about 40% by weight, such as in an amount less than about 35% by weight, such as in an amount less than about 30% by weight, such as in an amount less than about 25% by weight, such as in an amount less than about 20% by weight.

Various other components and additives can be incorporated into the porous polymer product of the present disclosure. Such additives include acid scavengers, heat stabilizers, light stabilizers, UV absorbers, lubricants (mold release agent), mechanical reinforcement materials such as carbon fibers, density modifiers, and mixtures thereof.

In one embodiment, an acid scavenger can be incorporated into the porous polymer product. The acid scavenger, for instance, may comprise an alkali metal salt or an alkaline earth metal salt. The salt can comprise a salt of a fatty acid, such as a stearate, or another organic acid, such as citric acid. Other acid scavengers include carbonates, oxides, or hydroxides. Particular acid scavengers that may be incorporated into the polymer composition include a metal stearate, such as calcium stearate, or tricalcium citrate. Still other acid scavengers include zinc oxide, calcium carbonate, magnesium oxide, and mixtures thereof.

In one embodiment, a heat stabilizer may be present in the composition. The heat stabilizer may include, but is not limited to, phosphites, aminic antioxidants, phenolic antioxidants, or any combination thereof.

In one embodiment, an antioxidant may be present in the composition. The antioxidant may include, but is not limited to, secondary aromatic amines, benzofuranones, sterically hindered phenols, or any combination thereof.

In one embodiment, a light stabilizer may be present in the composition. The light stabilizer may include, but is not limited to, 2-(2′-hydroxyphenyl)-benzotriazoles, 2-hydroxy-4-alkoxybenzophenones, nickel containing light stabilizers, 3,5-di-tert-butyl-4-hydroxybenzoates, sterically hindered amines (HALS), or any combination thereof.

In one embodiment, a UV absorber may be present in the composition in lieu of or in addition to the light stabilizer. The UV absorber may include, but is not limited to, a benzotriazole, a benzoate, or a combination thereof, or any combination thereof.

In one embodiment, a lubricant may be present in the composition. The lubricant may include, but is not limited to, silicone oil, waxes, molybdenum disulfide, or any combination thereof.

These additives may be used singly or in any combination thereof. In general, unless stated otherwise, if the additives are utilized, they may be present in an amount of at least about 0.05 wt. %, such as at least about 0.1 wt. %, such as at least about 0.25 wt. %, such as at least about 0.5 wt. %, such as at least about 1 wt. % and generally less than about 20 wt. %, such as less than about 10 wt. %, such as less than about 5 wt. %, such as less than about 4 wt. %, such as less than about 2 wt. %.

The porous polymer product of the present disclosure can then be formed through a sintering process. Porous articles may be formed by a free sintering process which involves introducing the polybenzimidazole particles into either a partially or totally confined space, e.g., a mold, and subjecting the molding powder to heat sufficient to cause the polybenzimidazole particles to soften, expand and contact one another. Suitable processes include compression molding and casting. The mold can be made of steel, aluminum or other metals. The polybenzimidazole powder used in the molding process can be ex-reactor grade, by which is meant the powder does not undergo sieving or grinding before being introduced into the mold. The additives discussed above may of course be mixed with the powder.

In one embodiment, a mold is first filled with a polybenzimidazole resin (step (1): filling step), where the resin can be dried in advance. In one aspect, the mold can first be preheated. Before this step, the mold can be preheated to a temperature ranging from 100° C. to 450° C. (preheating step) in order to attain quick heating to shorten the production cycle.

If the polybenzimidazole resin has not been preheated, it is heated in the filling step. In this case, therefore, the filling step and the resin-preheating step are to be effected in parallel. Further, it is desirable to ram, by pressing, the polybenzimidazole resin contained in the mold before effecting the heating step, thereby expelling the air present in the resin particles to the outside of the system. For this purpose, a pressure ranging from 50 to 400 kg/cm² is generally applied to the resin. The time required for the application of this pressure varies depending upon the size, shape, etc. of a sintered article of the resin to be finally obtained, and, it is generally 30 minutes or less. Moreover, before conducting this pressing, graphite, glass, glass fiber, carbon fiber, or any other filler containing substantially no volatiles, selected depending on the desired properties may be incorporated into the polybenzimidazole resin. The platen of a pressing machine is then firmly fixed at such a position that the polybenzimidazole resin can be densely packed in the mold placed under the platen. In the case where pressure has been applied to the resin for ramming, the pressure is released to 0 kg/cm².

After the filling step, the mold is heated to a temperature at which the subsequent sintering step is effected (step (2): heating step). Throughout this heating step, no pressure should be applied to the mold from the outside. Namely, the platen of the pressing machine is remained fixed at the above-described position. Under such a condition, the pressure applied by the pressing machine to the mold placed under the platen is equal to 0 kg/cm². The mold is heated to a predetermined temperature ranging from 500° C. to 600° C. In this step, the initial temperature of the mold can be 100 to 450° C. when the mold has been preheated, and room temperature, when the mold has not been preheated. In this step of heating, no pressure is applied to the polybenzimidazole resin by the pressing machine. Therefore, even if gases are emitted due to the decomposition of the polybenzimidazole resin, they can easily pass through spaces in the mold, and flee to the outside of the system. It is thus possible to decrease the volume of voids that will remain in the resulting sintered article of the polybenzimidazole resin. The heating step is effected by a heater built in the mold, or by any other heating means capable of heating the resin to the above-described extent. It is favorable to use a mold coupled with a pressing machine when the subsequent sintering step is taken into consideration. It is preferable to effect the heating step over a period of 90 to 150 minutes.

After the above-described step of heating, sintering is conducted by applying a predetermined pressure to the mold that has been heated to the sintering temperature, while maintaining the temperature (step (3): sintering step). Specifically, a predetermined pressure ranging from 50 kg/cm² to 750 kg/cm², preferably ranging from 200 kg/cm² to 450 kg/cm², which is needed to conduct sintering, is applied to the mold while holding the mold at the above-described temperature ranging from 500° C. to 600° C. It is desirable to keep, as much as possible, the pressure and temperature in the above-described ranges. For this purpose, there may be used an apparatus capable of restoring the pressure and the temperature to the predetermined ones by means of a thermostat or the like when the pressure and the temperature deviate from the acceptable ranges. The sintering time may be properly determined depending on the size, thickness, shape, etc. of a sintered article to be obtained. In general, however, it is from 15 to 200 minutes, preferably from 30 to 100 minutes. By the time the sintering step is effected, the gases emitted in the heating step by the decomposition of the polybenzimidazole resin have been mostly expelled to the outside of the system. It is therefore possible, in the sintering step, to thoroughly apply pressure to the polybenzimidazole resin. The contact area between the polybenzimidazole resin particles is thus increased; this makes it possible to obtain a sintered article having high strength.

After the mold has been heated to the predetermined temperature in the heating step, and before effecting the sintering step, the mold is held at the temperature for a certain period of time without application of pressure. By doing so, it is possible to prevent gases emitted in the heating step from being expelled insufficiently and from remaining in the resulting sintered article. In this case, the heat retaining time is generally from 0 to 100 minutes.

In one aspect, sintering of the polybenzimidazole polymer can occur in an oxygen depleted environment. Preventing oxygen from contacting the polybenzimidazole polymer during sintering, for instance, can prevent oxidation. In one aspect, the polybenzimidazole polymer is prevented from contacting oxygen during preheating and sintering.

For example, in one embodiment, preheating, loading of the polybenzimidazole polymer into the mold, and sintering can occur in an atmosphere comprised of one or more inert gases. Alternatively, sintering can occur under vacuum. Inert gases that can be used include argon, nitrogen, or the like.

After the polybenzimidazole polymer particles are sintered, the mold can be cooled and the porous polymer product can be removed.

Porous polymer products made in accordance with the present disclosure can have any suitable shape. In one embodiment, for instance, the porous polymer product can be formed into the shape of solid structures that can then be used to form a filtering bed for contact with a fluid. The porous polymer product, in one aspect, has at least one dimension that has a length of greater than about 0.8 mm, such as greater than about 1 mm, such as greater than about 1.5 mm, such as greater than about 2 mm, such as greater than about 2.5 mm, such as greater than about 3 mm, such as greater than about 3.5 mm, such as greater than about 4 mm, such as greater than about 5 mm, and generally less than about 500 mm, such as less than about 400 mm, such as less than about 300 mm, such as less than about 200 mm, such as less than about 100 mm, such as less than about 80 mm, such as less than about 60 mm, such as less than about 40 mm, such as less than about 20 mm.

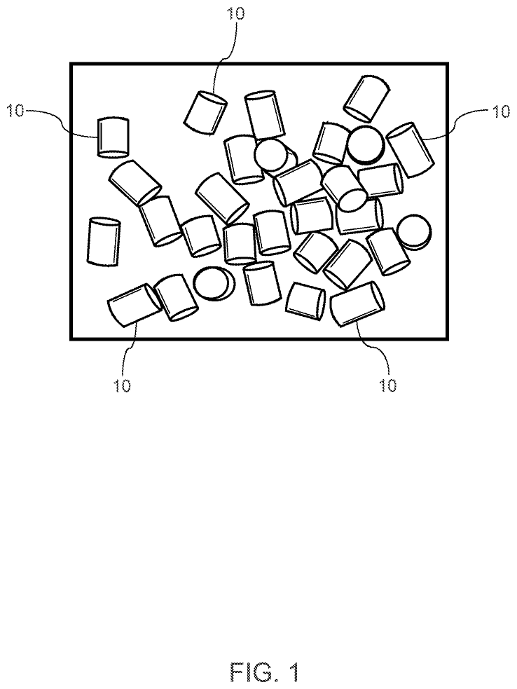

Referring to FIG. 1, one embodiment of a porous polymer product 10 made in accordance with the present disclosure is shown. In this example, the porous polymer product 10 is in the shape of a cylinder. For exemplary purposes only, for instance, in one embodiment, the cylinder can have a length of from about 2 mm to about 15 mm, including all increments of 1 mm therebetween. For instance, the cylinder can have a length of greater than about 2 mm, such as greater than about 3 mm, such as greater than about 4 mm, and generally less than about 12 mm, such as less than about 10 mm, such as less than about 8 mm, such as less than about 6 mm. The diameter of the cylinder can generally be greater than about 0.5 mm, such as greater than about 0.8 mm, such as greater than about 1 mm, such as greater than about 1.5 mm, such as greater than about 2 mm, such as greater than about 2.5 mm. The diameter of the cylinder can generally be less than about 12 mm, such as less than about 10 mm, such as less than about 8 mm, such as less than about 6 mm, such as less than about 4 mm. In one particular embodiment, the cylinders 10 can have a length of from about 3 mm to about 7 mm and a diameter of from about 1 mm to about 5 mm.

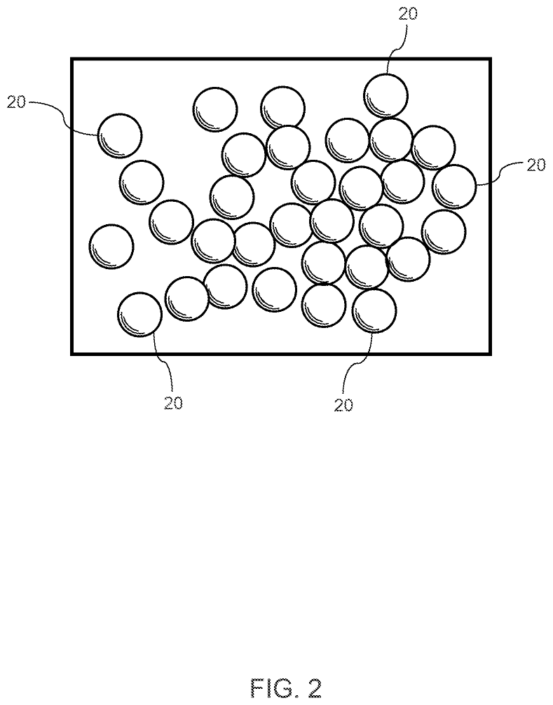

Referring to FIG. 2, another embodiment of a porous polymer product 20 made in accordance with the present disclosure is shown. In the embodiment illustrated in FIG. 2, the product 20 is in the shape of spheres. Again, the spheres can have any suitable size depending upon the particular application. For instance, the spheres can have a diameter of greater than about 0.5 mm, such as greater than about 0.8 mm, such as greater than about 1 mm, such as greater than about 1.5 mm, such as greater than about 2 mm, such as greater than about 2.5 mm, such as greater than about 3 mm, and generally less than about 12 mm, such as less than about 10 mm, such as less than about 8 mm, such as less than about 6 mm, such as less than about 4 mm, such as less than about 2 mm.

In other embodiments, various other shapes can be used. As shown in FIGS. 1 and 2, non-planar and non-tubular shapes have been found to be particularly well suited for filtering fluids in accordance with the present disclosure, especially in view of the porous structure of products made according to the present disclosure. In other embodiments, however, the porous polymer product can be in the shape of disks that may provide a large surface area on at least two surfaces. For instance, each disk can have a thickness of less than about 3 mm, such as less than about 1 mm, and can have a diameter of from about 4 mm to about 12 mm, including all increments of 1 mm therebetween.

In one embodiment, the porous polymer product is net shape molded, meaning that the size and shape of the product is not changed after sintering and exiting the mold. In other embodiments, however, the porous polymer product can be formed in accordance with the present disclosure and then cut or ground to a desired size and/or shape. For example, in one embodiment, the porous polymer product can be formed into a long rod or into any of the shapes illustrated in FIGS. 1 and 2 and then subjected to a grinding process that produces a granular product with irregular shapes. The ground product, however, still can maintain at least one largest dimension of greater than about 0.8 mm, such as greater than about 1 mm, such as greater than about 1.5 mm, such as greater than about 2 mm, such as greater than about 2.5 mm. Grinding the product into irregular shapes can produce an irregular surface that may provide greater surface area for contact with fluids.

Porous polymer products made according to the present disclosure offer numerous advantages and benefits due to the properties that are obtained through the selection of materials and the sintering process as described above. For example, porous polymer products made according to the present disclosure can contain a chemical scavenger in relatively great amounts. For example, the porous polymer product of the present disclosure can contain one or more polybenzimidazole polymers in an amount greater than about 60% by weight, such as in an amount greater than about 70% by weight, such as in an amount greater than about 80% by weight, such as in an amount greater than about 90% by weight, such as in an amount greater than about 95% by weight, such as in an amount greater than about 97% by weight, such as in an amount greater than about 98% by weight, such as in an amount greater than about 99% by weight. Forming the porous polymer product almost exclusively from a chemical scavenger can dramatically improve process efficiencies. Of particular advantage, the porous polymer products can be made without the use of a binder or any other polymers.

In addition to having relatively high loading of the chemical scavenger, the porous polymer products of the present disclosure can be formed with excellent pore structures that facilitate contact with fluids in order to remove contaminants from the fluid. For instance, the porous polymer product can have a porosity of greater than about 10%, such as greater than about 15%, such as greater than about 20%, such as greater than about 25%, such as greater than about 30%, such as greater than about 35%, such as greater than about 40%, such as greater than about 45%, such as greater than about 50%, such as greater than about 55%, such as greater than about 60%, such as greater than about 65%, and generally less than about 85%, such as less than about 80%, such as less than about 70%. Porosity can be determined according to DIN Test 66133.

Average pore size which can also be determined according to Test DIN 66133 can generally be greater than about 4 nm, such as greater than about 4.2 nm, such as greater than about 4.4 nm, such as greater than about 4.6 nm, such as greater than about 4.8 nm, such as greater than about 5 nm, such as greater than about 5.2 nm, such as greater than about 5.4 nm, such as greater than about 5.6 nm, and less than about 30 nm, such as less than about 20 nm, such as less than about 15 nm, such as less than about 10 nm, such as less than about 8 nm.

The porous polymer products can also display a BET surface area of greater than about 0.03 m²/g, such as greater than about 0.05 m²/g, such as greater than about 0.07 m²/g, such as greater than about 0.09 m²/g, such as greater than about 0.11 m²/g, such as greater than about 0.13 m²/g, such as greater than about 0.15 m²/g, such as greater than about 0.17 m²/g, such as greater than about 0.19 m²/g, such as greater than about 0.21 m²/g, such as greater than about 0.23 m²/g, such as greater than about 0.25 m²/g, such as greater than about 0.27 m²/g, such as greater than about 0.29 m²/g, such as greater than about 0.31 m²/g, such as greater than about 0.33 m²/g, such as greater than about 0.35 m²/g, such as greater than about 0.37 m²/g, and less than about 0.7 m²/g. BET surface area can be measured according to ISO Test 9277:2010.

Porous polymer products made according to the present disclosure can be used in numerous and diverse applications for removing chemical species from a fluid, such as a liquid stream. For instance, the porous polymer products of the present disclosure can be used to contact fluids in a water treatment process, in the food and beverage industry, in the pharmaceutical industry, in the oil and gas industry, in the chemical industry, in the pulp and paper industry, and the like. The porous polymer product of the present disclosure, for instance, can be used to remove trace amounts of metals, proteins, polypeptides, organic compounds, and the like from any liquid body or stream.

For example, in many pharmaceutical manufacturing processes, metal contaminants need to be removed during different stages of the process. For example, transition-metal catalysts are typically used to construct chemicals, including small molecule pharmaceuticals. Although use of the catalysts provide numerous advantages to producing the compounds, the catalysts have a tendency to produce metal species which become a contaminant that can have an adverse impact on downstream chemical processes. In addition, many government regulations and guidelines require that metal impurities be maintained below certain levels in final active pharmaceutical ingredients. The porous polymer products of the present disclosure are particularly well suited to removing metal contaminants in pharmaceutical processes without any adverse impact upon the final product.

In one embodiment, the porous polymer product of the present disclosure can be used to remove a precious metal, particularly rhodium, from a carbonylation process. One particularly significant industrial process is the carbonylation of methanol to make acetic acid. To make acetic acid, methanol is carbonylated in a reaction medium wherein rhodium is utilized as a catalyst. The catalyst has a tendency to form volatile species which leads to catalyst loss and rhodium becomes entrained in the process streams. The porous polymer product of the present disclosure is particularly well suited for removing rhodium from a liquid stream in a carbonylation process.

The carbonylation apparatus or process includes generally at least a reactive section, and a purification section. The process may include, for example, the carbonylation of methanol with carbon monoxide in a homogeneous catalytic reaction system comprising a reaction solvent (typically acetic acid), methanol and/or its reactive derivatives, a soluble rhodium catalyst, at least a finite concentration of water, as well as the porous scavenger product of the present disclosure. The carbonylation reaction proceeds as methanol and carbon monoxide are continuously fed to the reactor. The carbon monoxide reactant may be essentially pure or may contain inert impurities such as carbon dioxide, methane, nitrogen, noble gases, water and C₁ to C₄ paraffinic hydrocarbons. The presence of hydrogen in the carbon monoxide and generated in situ by the water gas shift reaction is preferably kept low, for example, less than 1 bar partial pressure, as its presence may result in the formation of hydrogenation products. The partial pressure of carbon monoxide in the reaction is suitably in the range 1 to 70 bar, preferably 1 to 35 bar, and most preferably 1 to 15 bar.

The pressure of the carbonylation reaction is suitably in the range 10 to 200 bar, preferably 10 to 100 bar, most preferably 15 to 50 bar. The temperature of the carbonylation reaction is suitably in the range 100 to 300° C., preferably in the range 150 to 220° C. Acetic acid is typically manufactured in a liquid phase reaction at a temperature of from about 150-200° C. and a total pressure of from about 20 to about 50 bar.

Acetic acid is typically included in the reaction mixture as the solvent for the reaction.

Suitable reactive derivatives of methanol include methyl acetate, dimethyl ether, methyl formate and methyl iodide. A mixture of methanol and reactive derivatives thereof may be used as reactants in the process. Preferably, methanol and/or methyl acetate are used as reactants. At least some of the methanol and/or reactive derivative thereof will be converted to, and hence present as, methyl acetate in the liquid reaction composition by reaction with acetic acid product or solvent. The concentration in the liquid reaction composition of methyl acetate is suitably in the range 0.5 to 70% by weight, preferably 0.5 to 50% by weight, more preferably 1 to 35% by weight and most preferably 1-20% by weight.

Water may be formed in situ in the liquid reaction composition, for example, by the esterification reaction between methanol reactant and acetic acid product. Water may be introduced to the carbonylation reactor together with or separately from other components of the liquid reaction composition. Water may be separated from other components of reaction composition withdrawn from the reactor and may be recycled in controlled amounts to maintain the required concentration of water in the liquid reaction composition. The concentration of water can be maintained in the liquid reaction composition is in the range 0.1 to 16% by weight.

The reaction liquid is typically drawn from the reactor and flashed in a one step or multi-step process using a converter as well as a flash vessel as hereinafter described. The crude vapor process stream from the flasher is sent to a purification system which generally includes at least a light ends column and a dehydration column.

In accordance with the present disclosure, a process stream that may be located in the purification section containing rhodium can be contacted and treated with the porous polymer product of the present disclosure. For example, the polybenzimidazole polymer contained in the porous polymer product is well suited to removing rhodium from the fluid stream.

The process stream being treated in accordance with the present disclosure can contain very low amounts of the contaminant, such as rhodium. For instance, the amount of rhodium in the process stream can be less than about 10,000 ppb, such as less than about 1,000 ppb, such as less than about 500 ppb, such as less than about 300 ppb, such as less than about 200 ppb, such as less than about 100 ppb, such as even less than about 50 ppb. The porous polymer product of the present disclosure can effectively remove all of the rhodium from the process stream such that rhodium levels are below detectable limits.

After scavenging the rhodium or metal ion, the metal ion can be subsequently recovered by digesting the polymer through incineration or according to a process in which the porous polymer product can be reused. For instance, an ion-exchange regeneration technique can be used with ammonium salts, sulfuric acid, or hydrochloric acid for recovering the metal.

In one embodiment, sequestered catalyst metal is removed from the resin by using a regenerant including a regenerant solvent and one or more regenerating agents compatible with the reaction system. The recovered catalyst metal can then be directly recycled to the reactor and the resin re-used to improve system economics and reduce environmental impact. Suitable regenerant solvents for regenerating the resin include water, acetic acid, methyl acetate, methyl formate methanol and mixtures thereof. Suitable regenerating agents include soluble Group IA and Group IIA metal salts and hydroxides as well as hydrogen halides. Exemplary regenerant compositions for regenerating the resin bed thus include aqueous solutions of: lithium acetate; lithium carbonate; lithium hydroxide; lithium iodide; hydrogen iodide; potassium hydroxide; potassium iodide; sodium acetate; sodium iodide; sodium carbonate; sodium hydroxide and so forth.

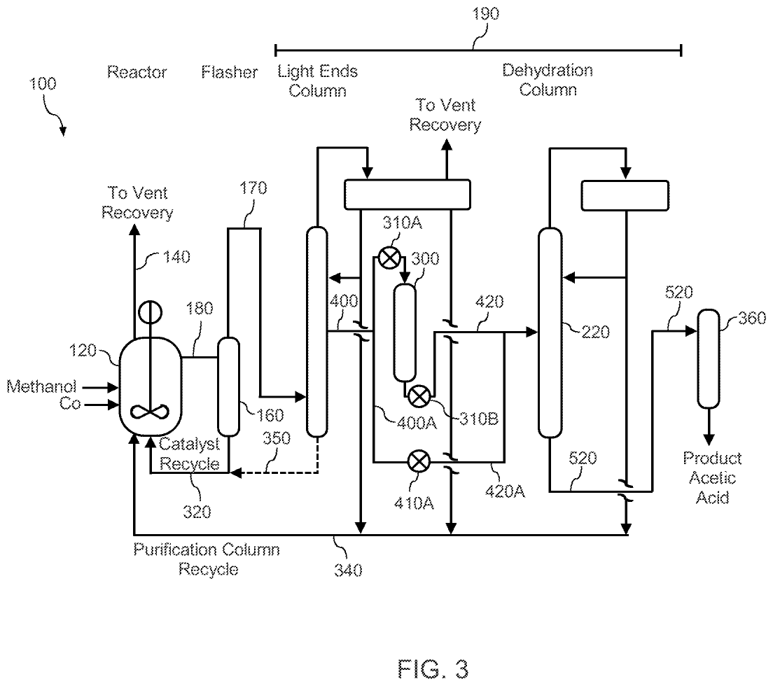

Referring to FIG. 3, a schematic diagram is shown illustrating a typical carbonylation process which includes a catalyst sequestering system. In FIG. 3, there is shown a carbonylation system 100 including a reactor 120 provided with a vent 140. Reactor 120 is coupled to a flasher 160 by way of a conduit 180. The flasher, in turn, is coupled to a purification section 190 which comprises generally a light ends column 200, a dehydration column 220 and a strong acid, silver-exchanged cation ion-exchange resin bed 360 which removes iodides from the product.

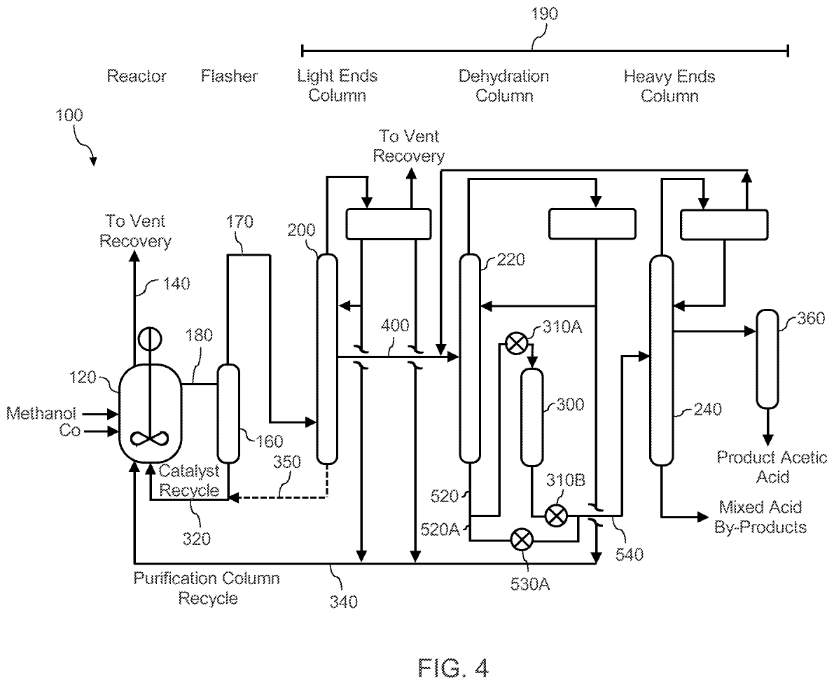

A gaseous purge stream is typically vented from the head of the reactor to prevent buildup of gaseous by-products such as methane, carbon dioxide and hydrogen and to maintain a set carbon monoxide partial pressure at a given total reactor pressure. Optionally, a so-called “converter” reactor can be employed which is located between the reactor and flasher vessel shown in FIGS. 3 and 4. The “converter” produces a vent stream comprising gaseous components which are typically scrubbed with a compatible solvent to recover components such as methyl iodide and methyl acetate. The gaseous purge streams from the reactor and converter can be combined or scrubbed separately and are typically scrubbed with either acetic acid, methanol or mixtures of acetic acid and methanol to prevent loss of low boiling components such as methyl iodide from the process. If methanol is used as the vent scrub liquid solvent, the enriched methanol from the scrubbing system is typically returned to the process by combining with the fresh methanol feeding the carbonylation reactor, although it can also be returned into any of the streams that recycle back to the reactor such as the flasher residue or light ends or dehydration column overhead streams. If acetic acid is used as the vent scrub liquid solvent, the enriched acetic acid from the scrubbing system is typically stripped of absorbed light ends and the resulting lean acetic acid is recycled back to the absorbing step. The light end components stripped from the enriched acetic acid scrubbing solvent can be returned to the main process directly or indirectly in several different locations including the reactor, flasher, or purification columns. Optionally, the gaseous purge streams may be vented through the flasher base liquid or lower part of the light ends column to enhance rhodium stability and/or they may be combined with other gaseous process vents (such as the purification column overhead receiver vents) prior to scrubbing.

In accordance with the present disclosure, a bed comprising the porous polymer product of the present disclosure is present in the process as indicated at 300 on the purified process stream 400.

As will be appreciated by one of skill in the art, the different chemical environments encountered in the purification train may require different metallurgy. For example, a resin bed at the outlet of the light ends column will likely require a zirconium vessel due to the corrosive nature of the process stream, while a vessel of stainless steel may be sufficient for resin beds placed downstream of this dehydration column where conditions are much less corrosive.

Carbon monoxide and methanol are introduced continuously into reactor 112 with adequate mixing at a high carbon monoxide partial pressure. The non-condensable bi-products are vented from the reactor to maintain an optimum carbon monoxide partial pressure. The reactor off gas is treated to recover reactor condensables, i.e., methyl iodide before flaring. Methanol and carbon monoxide efficiencies are preferably greater than about 98 and 90% respectively.

From the reactor, a stream of the reaction mixture is continuously fed via conduit 180 to flasher 160. Through the flasher the product acetic acid and the majority of the light ends (methyl iodide, methyl acetate, water) are separated from the reactor catalyst solution, and the crude process stream 170 is forwarded with dissolved gases to the distillation or purification section 190 in a single stage flash. The catalyst solution is recycled to the reactor via conduit 320. Under the process conditions of the flash, rhodium is susceptible to deactivation at the low carbon monoxide partial pressures in the flash vessel and may be entrained to purification system 190.

The purification of the acetic acid typically includes distillation in a light ends column, a dehydration column, and, optionally, a heavy ends column. The crude vapor process stream 170 from the flasher is fed into the light ends column 200. Methyl iodide, methyl acetate, and a portion of the water condense overhead in the light end columns to form two phases (organic and aqueous). Both overhead phases return to the reaction section via recycle line 340. The dissolved gases from the light ends column vent through the distillation section. Before this vent stream is flared, residual light ends are scrubbed and recycled to the process. Optionally, a liquid recycle stream 350 from the light ends column may also be returned to the reactor.

The purified process stream 400 can be drawn off the side of the light end column 200 and fed to a vessel 300 containing the porous polymer product of the present disclosure. The vessel 300, for instance, can be filled with cylinders, spheres, or other shapes as may be desired formed from the porous polymer product. As described above, the porous polymer product contains polybenzimidazole that is well adapted to removing precious metals, such as rhodium.

The exit process stream 420 from the polymer bed is then fed into dehydration column 220. Water and some acetic acid from this column separate and are recycled to the reaction system via recycle line 340 as shown. The purified and dried process stream 520 from the dehydration column 220 feeds resin bed 360 and product is taken therefrom as shown. Carbonylation system 100 uses only two purification columns and is preferably operated as described in more detail in U.S. Pat. No. 6,657,078 and in U.S. Pat. No. 7,902,398, which are both incorporated herein by reference.

System 100 is optionally provided with a bypass lines 400A, 420A with a valve 410A. Bed 300 has a pair of valves 310A, 310B which can be used to isolate the bed during regeneration or replacement of the resin. For example, during normal operation, valves 310A, 310B are open and valve 410A is closed so that the process stream is treated in resin bed 300. If so desired, some or all of the process stream may be directed through lines 400A, 420A by opening valve 410A and closing, or partially closing, valves 310A, 310B.

In FIG. 3, the product acetic acid is afforded as the residue of the dehydration column as shown.

FIG. 4 illustrates another embodiment where the process is similar to the one described in connection with FIG. 3, except the catalyst sequestering unit 300 is positioned after the dehydration column 220 and a heavy ends purification column is included. Here, the purified and dried process stream 520 from the dehydration column 220 is fed into polymer bed 300. The exit process stream 540 from the polymer bed 300 is then fed into a heavy ends column 240 which, in turn, feeds iodide removal bed 360 via a side drawn from the column.

System 100 of FIG. 4 is likewise optionally provided with a bypass line 520A with a valve 530A. Bed 300 has a pair of valves 310A, 310B which can be used to isolate the bed during regeneration or replacement of the resin, as is noted above.

The porous polymer product of the present disclosure can be used in other numerous processes in addition to the process described above for making acetic acid. For instance, the porous polymer product of the present disclosure can be used to remove contaminants, such as metal ions, from a liquid stream during the production of a beverage. Metal ions, for instance, can be present in a beverage stream as a contaminant from process waters for cleaning. The porous polymer product of the present disclosure can contain any suitable chemical scavenger for removing any metal contained in the beverage stream.

In an alternative embodiment, the porous polymer product of the present disclosure can be used to remove polypeptides and/or polyphenols from liquid streams, such as liquid streams that are used to produce beverages, such as beer. In this regard, the porous polymer product of the present disclosure can be formulated so as to be completely safe for food contact applications.

In addition to beer, various other beverages that can be filtered using the porous polymer product of the present disclosure include other alcoholic beverages including wine, cider, whiskey, gin, rum, tequila, brandy, and vodka. Other beverages include various fruit juices including apple juice, orange juice, pineapple juice, peach juice, pear juice, and cranberry juice. In still another embodiment, the treated liquid can be a vinegar, such as a malt vinegar, a wine vinegar, or a cider vinegar.

In each of the above described beverages, the beverages can be contacted with the porous polymer product containing polybenzimidazole for removing polyphenols, polypeptides, proteins, and the like. Even if the beverages contain very small amounts of polyphenols, the porous polymer product of the present disclosure can remove the polyphenols to undetectable levels.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A process for removing contaminants from a fluid stream comprising:
contacting a fluid stream containing at least one contaminant with a porous filter element, the porous filter element comprising a porous structure formed from a chemical scavenger, the chemical scavenger comprising polybenzimidazole; and
wherein the contaminant comprises an ion that binds to the chemical scavenger contained in the porous structure of the porous filter element.

2. A process as defined in claim 1, wherein the polybenzimidazole has been sintered together to form the porous filter element.

3. A process as defined in claim 1, wherein the polybenzimidazole comprises at least about 60% by weight of the porous filter element.

4. A process as defined in claim 1, wherein the contaminant comprises metal ions or complexes thereof.

5. A process as defined in claim 1, wherein the contaminant comprises an ion of rhodium, palladium, platinum, iron, copper, mercury, or mixtures thereof or complexes thereof.

6. A process as defined in claim 1, wherein the fluid stream is fed to a cartridge containing a plurality of the porous filter elements.

7. A process as defined in claim 4, wherein the plurality of the porous filter elements form a fixed bed in the cartridge through which the fluid steam is filtered.

8. A process as defined in claim 1, further comprising the step of removing and recovering the contaminant from the chemical scavenger.

9. A process as defined in claim 1, wherein the fluid stream is part of a pulp and paper process, part of a water treatment process, part of a beverage purification process, part of an oil and gas process, part of a catalyst recovery process, part of a pharmaceutical process, or part of a chemical purification process.

10. A process according to claim 1, wherein the porous filter element has an average pore size of greater than about 4.5 nm.

11. A process according to claim 1, wherein the chemical scavenger is not immobilized on a solid carrier.

12. A process according to claim 1, wherein the porous filter element is net shape molded.

13. A process according to claim 1, wherein the porous filter element has a solid cylindrical shape or solid spherical shape.

14. A process according to claim 1, wherein the polybenzimidazole has been sintered together and then ground into granules to form the porous filter elements.

15. A process as defined in claim 1, wherein the porous filter element is made exclusively from the polybenzimidazole.

16. A device for filtering fluids comprising:
a cartridge including a fluid inlet and a fluid outlet, the cartridge defining an interior enclosure; and
a bed of unfastened porous filter elements loaded into the interior enclosure of the cartridge, the unfastened porous filter elements having a greatest dimension of at least 0.5 mm, each porous filter element comprising a porous structure, each porous filter element being formed from a chemical scavenger, the chemical scavenger comprising polybenzimidazole, the chemical scavenger being exposed to fluids flowing through the cartridge.

17. A device as defined in claim 16, wherein the porous filter elements have a solid spherical or solid cylindrical shape.

18. A device as defined in claim 16, wherein the polybenzimidazole has been sintered together to form the porous filter elements.

19. A device as defined in claim 16, wherein each porous filter element comprises polybenzimidazole in an amount of at least about 60% by weight.

20. A device as defined in claim 16, wherein the porous filter elements have an average pore size of greater than about 4.5 nm.

21. A porous filter element comprising:
a porous substrate being formed from a sintered chemical scavenger, the chemical scavenger comprising polybenzimidazole, the porous substrate comprising at least about 60% by weight of the polybenzimidazole, the porous substrate being configured to be contacted with fluids so that the fluids contact the polybenzimidazole, the porous substrate having an average pore size of greater than about 4.5 nm.
